(19) United States
(12) Patent Application Publication
(10) Pub. No.: US 2012/0159133 A1
(43) Pub. Date: Jun. 21, 2012

(54) BUSINESS EXCEPTION MANAGEMENT PATTERN FOR BUSINESS PROCESSES

(75) Inventors: Rajat Talwar, Gurgaon (IN); Tapas Kumar Nayak, Gachibowli (IN)

(73) Assignee: Microsoft Corporation, Redmond, WA (US)

(21) Appl. No.: 12/972,077

(22) Filed: Dec. 17, 2010

(51) Int. Cl. G06F 9/38

(52) U.S. Cl. 712/244; 712/E09.06

(57) ABSTRACT

Handling business process exceptions. A method includes a computing system using a template, causing one or more operations to be performed to determine a problem that caused a business process exception. The computing system uses a template to cause one or more operations to be performed to perform one or more repair operations to address the business process exception. The computing system uses a template, to cause one or more operations to be performed to take action on the business process exception.

### BACKGROUND

### Background and Relevant Art

Computers and computing systems have affected nearly every aspect of modern living. Computers are generally involved in work, recreation, healthcare, transportation, entertainment, household management, etc.

Computing systems can be used to manage business processes. For example, automated systems may be used for inventory control, accounting, sales, marketing, company policy management, etc. These automated systems may interact with each other to accomplish one or more business processes. For example, consider an on-line retailer. Marketing may include email servers for sending advertisements, and a web based storefront. When a customer orders a product, there may be credit card processing systems to accept payment from the system, and warehouse and inventory control systems to fulfill the customer's order. Accounting systems may track profits and losses based on sales. Reporting systems may collect data from various other systems and provide reports to management, or to company professionals as needed.

Business process modeling includes modeling expected business exceptions. An exception is some event or value that interferes with a normal or ideal flow of business processes. Unexpected, inconsistent, and/or missing data, and incomplete business transactions are some common causes leading to business exceptions. For example, a customer's credit card being declined could be an exception. An indication that a transaction may be fraudulent could be an exception. A known violation of a company policy may be an exception. A compliance check failure could be an exception. While not enumerated here an almost countless number of other events could be classified as exceptions. These exceptions need to be handled and/or repaired.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method of handling business process exceptions. The method includes a computing system using a template, causing one or more operations to be performed to determine a problem that caused a business process exception. The computing system uses a template to cause one or more operations to be performed to perform one or more repair operations to address the business process exception. The computing system uses a template, to cause one or more operations to be performed to take action on the business process exception.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a business processing exception flow; and

FIG. 2 illustrates a business network including an application fabric.

### DETAILED DESCRIPTION

Business processing involves handling business exceptions. As defined by some best practices it may be better not to mix handling business exceptions with the main business handling logic. There are a number of reasons for this. For example, the exception handling and/or repairing code itself can be quite complex. Another reason is that there are different service level agreements (SLA's) or auditing and analytical requirements for cases with business exceptions. Another reason is that the cost to the company for cases where exceptions occur might be higher. Another reason is that business exceptions and their repair quite often involve human workflow and strict business requirements, such as for example approvals, which might not be part of the main business flow handling logic or automated portions of business flow logic.

Embodiments described herein illustrate solutions that include one or more of modeling, managing or monitoring business exceptions. Some embodiments described herein implement methods and/or systems that use a framework and one or more templates pluggable into the frame work to find exceptions, fix exceptions and take action on the exceptions. In particular, embodiments may be configured, using templates, to find business exceptions, fix problems causing business exceptions, and take action after problems have been fixed. Using templates, embodiments may be configured to find the exact problem. This can be done by analysis to discover the real problem. Using the templates, embodiments can fix the problem. This can be done, for example, by repairing messages or objects, getting various approvals, making a call to a service etc. Once the problem has been fixed, embodiments may include functionality for taking action on the problem. For example, messages may be resubmitted, and/or process flows may be continued or restarted. If necessary, embodiments may be able to abort a process flow at any of the three states mention above.

Modeling business exception handling, in some embodiments, may be broken down into three stages. First, embodiments may identify and define the possible exception cases that can occur in the business process. Second, embodiments may define the flow, logic and auditing for handling such cases. Third, embodiments may add the logic for routing such exceptions to the flow defined from the business process.

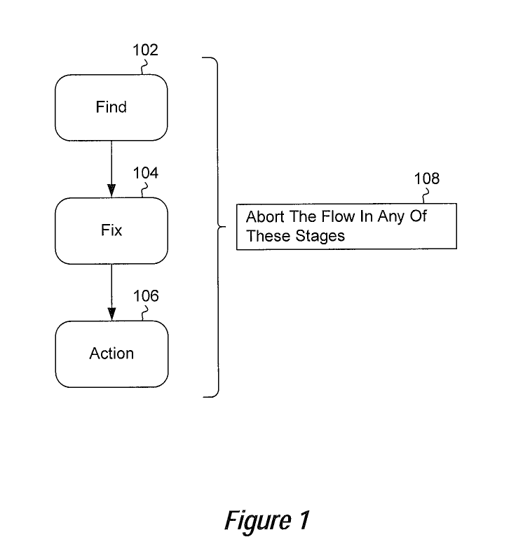

With an appropriate model in place, business exception handling may itself include three stages as illustrated by in FIG. 1. Namely, embodiments, may find problems (stage 102), fix problems (stage 104) and take action on problems (106). At any point in this flow, a flow an abort may be performed (stage 108). As illustrated at 102, embodiments may find the exact problem. In particular, embodiments may analyze information and circumstances related to a problem to analyze the issues and find out what is the real problem. Embodiments may identify errors causing exceptions using a set of prebuilt rule validator activities which run on the exception and messages associated with the exception. If, using the rules, errors can be determined, the errors can be converted to a format used by other portions of the exception handling components. Some embodiments may allow templates to specify human intervention or user input in helping to identify errors and find problems. Additionally, as part of the find stage, embodiments may, if possible, supply validators to verify fixes performed in the fix stage 104. At this point the issue causing the exception is known and can be fed for fixing to exception handling components used for fixing problems. Additionally, using validators, any fixes can be audited. Auditing may occur, for example, using SLAs or business intelligence.

As illustrated at 104, embodiments may include functionality for fixing the problem. In particular, various actions may be taken to repair messages, get an approval, make a call to a service etc. In some embodiments, the fixing stage 104 may involve three sub-stages including fixing the message, verifying the fix and approving the fix. Verifying the fix may include additional activities beyond simply using the validators supplied in the find stage 102. Some embodiments may include requesting user input from human users to perform parts of the fix stage. For example, users may be asked to correct messages or data. Users may be asked to verify or approve fixes. Or users may be asked to perform other actions associated with fixing a business exception. These user activities can be defined in a template used by a framework for handling business exceptions.

As illustrated at 106, embodiments may include functionality for taking action on a problem. For example, resubmit, restart and/or other actions may be taken. These actions may be automated, include user input, or both. This functionality may be defined by a template used in a framework. FIG. 1 further illustrates that throughout the stages of finding, fixing, and action, embodiments, may abort the exception handling processes at any time.

Using templates, the general concepts discussed above could be extended in a number of different ways. In particular, in some embodiments, each stage (i.e. find stage 102, fix stage 104 and taking action stage 106 can have multiple stages. For example, as a part of the find stage 102 for finding the problem messages may be routed from one department to another until the real problem is found. Similarly for a fix stage 104, embodiments may have multiple fixes, reviews, verification, testing and approval stages. Each of the stages can act as a stencil or an interface to the function the stage represents. This allows embodiments to be customized for implementation while still following common guidelines. Following common guidelines creates a more standardized implementation which increases the possibility of sharing among various implementations. Using a more standardized implementation allows for monitoring and/or tracking to be consistent and more seamless with changes. Using a more standardized implementation allows for business insights to be derived automatically. Using a more standardized implementation, each stage can be modeled as a service and the implementations can be determined at the runtime to allow greater flexibility.

Exceptions can be captured, such that they can be appropriately handled by exception components, in a number of different ways. For example, in some embodiments, exceptions can be captured using a business exception activity in a workflow. The business exception activity can route message and exception details to exception management solution components. In an alternative embodiment, exception management solution components may subscribe to a messaging server to have a subscription for failed messages.

Embodiments including elements as described above are useful in a number of different business exception handling and message repair environments. For example, such embodiments can be used in SWIFT message repair, ESB message repair or others.

As noted previously herein, a number of different systems and/or entities may work together in the running of a business. For example, automated systems may be used for inventory control, accounting, sales, marketing, company policy management, etc. These automated systems may interact with each other to accomplish one or more business processes. Additionally, typically there are human decision makers at many different levels involved in the running of a business. Human intervention may be needed for tasks like approval, manual searches, message or object modification, etc. Example of human decision makers may include warehouse workers, mail clerks, secretarial staff, customer service agents, information technology professionals, managers, officers, directors, etc. Thus, some embodiments use a template based workflow that is able to accommodate human actors together with automated machine implemented actors. For example, automated systems may be implemented to allow for generating reports or interfaces usable by the human actors. Input from the human actors can be returned back to the automated machine actors so that automated processing can continue. Templates can be created that can be used by business systems to accommodate this type of interaction. Various workflows can be implemented. For example, in some embodiments, fixed workflows for exception handling can be implemented. Applications in the application fabric can route exceptions to the correct workflow for handling. Alternatively, a single resolver based workflow system may be used. In these examples, embodiments may resolve on different roles based on message type, find results or change-lists.

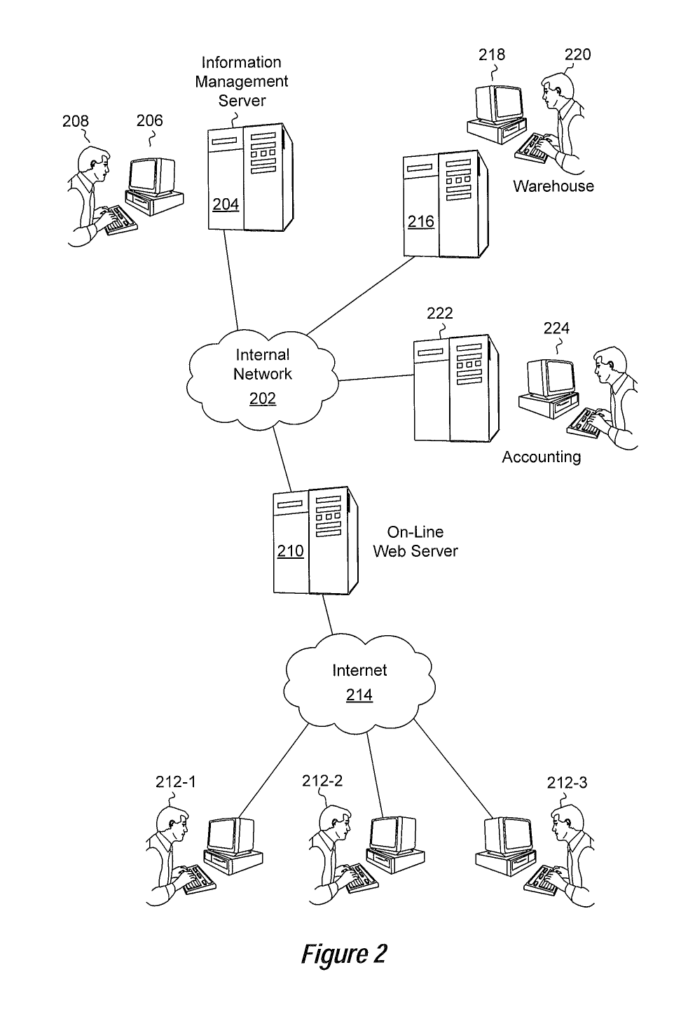

FIG. 2 illustrates an example of a business computing system including an application fabric and human decision makers. FIG. 2 illustrates a number of systems connected by an internal network 202. As shown, and as will be discussed, many of these systems include provisions for interaction with human decision makers. For example, FIG. 2 illustrates an information management server 204. The information management server 204 may include a number of different functions, including functions related to information technology management, reporting, etc. As illustrated, the information management server 204 may include provisions for a user interface 206 where a user 208 can access the functionality of the information management server 204. While the user interface 206 is shown next to the information management server 204, it should be noted that the user interface 206 (as with all user interfaces illustrated herein) may be implemented on a terminal remote from the information management server 204.

FIG. 2 illustrates an online web server 210. The online web server 210 may perform various functions related to advertising and implementing an online store front through which products are sold. As illustrated, customers 212-1, 212-2, and 212-3 (referred to herein generally as 212) can connect through the internet 214 to view items for sale and to purchase items. The online web server 210 may include payment functionality to interact with external payment enterprises (such as credit card handling enterprises) to receive payment.

During the ordering process, the online web server 210 can communicate with a warehouse server 216 through the internal network 202 to ensure that appropriate inventory is in place to fulfill orders. When an order is made, and payment is received, the warehouse server 216 is able to communicate through a user interface 218 with one or more warehouse workers 220 who can retrieve items purchased and send them to a customer 212.

The online web server 210, or other external payment entities, may communicate with an accounting server 222 to ensure that appropriate debits and credits are made for the ordering process. For example, an overall credit may be made for receipt of payment from a customer 212, while debits may be made for shipping costs and the like.

The infrastructure shown in FIG. 2 can implement an application fabric. In particular, different applications can be installed on various servers in the infrastructure. The applications and their implementation on the hardware servers represents the application fabric through which business processes are handled.

As noted, embodiments may implement a framework for business exception management. As described above, the framework may be templatized. Embodiments may include out of the box templates, i.e. template elements that can be provided with a turnkey system. However, use of the temples also allows for an extensible workflow framework based on templates defining business exception handling patterns. The templates are deployable into a business application fabric.

As noted, embodiments may include provisions for human workflow integration. For example, human intervention or interaction may be required for finding problems, data modification, and/or verification or approval activities. For example, in some embodiments, a user may be able to access a browser based portal that allows the user to interact with business workflow by providing information or approvals. In the example illustrated in FIG. 2, this may be accomplished using the information management server 204 and the user interface 206, the warehouse server 216 and the user interface 218, the accounting server 222 and user interface 224, etc. In some embodiments, tools such as SharePointe available from Microsoft Corporation of Redmond Wash. may be used to provide appropriate user interfaces and to make data available to other business systems. Thus, in some embodiments, a template may indicate at various points that human interaction is needed at different portions of finding, fixing, and taking action on problems.

Embodiments may include provisions for role based interactions. In particular, certain entities may need to take action on certain aspects of exception processing that are of no concern to other entities. For example, consider a product ordering scenario. Inventory control systems or warehouse servers 216 may not need to be concerned about what credit card was used to pay for a product, but merely rather that the product should be shipped to a given customer. Templates may define and control visibility of data based on roles. In the ordering example, warehouse server 216 may be provided, based on template definitions, only with indications that a product should be shipped and to where it should be shipped. In general, embodiments may include functionality for controlling visibility of data and making any data visible to a role understandable based on the role receiving the data.

Embodiments may be implemented where different roles can be assigned tasks. In particular, each unit of work that is to be performed involves one or more roles. A role is played by a person or a module implemented by executing code on a computing system. A role is involved in performing a task. Each task may be defined in a data contract defining how data is presented or accessed. Each task may need to change or access only a subset of data. Therefore data is transformed (or projected) to include the needed data while excluding other data before it is supplied to a task such that it is accessible by a role. The data may be inverse transformed when data is returned from a task. In some embodiments, each task activity picks up a task from a set of deployed tasks based on a stage resolver.

By using a template based approach, embodiments may have a consistent and predictable way of handling business exceptions. In particular, for a given business exception, use of a template will facilitate finding, fixing and taking action in a consistent way.

Embodiments may further be able to facilitate information worker empowerment. In particular, embodiments may facilitate administrative level changes for the exception handling process. For example, embodiments allow for managing permissions for approvals, managing permissions for viewing data etc. Additionally, the extensibility of the embodiments allows for reassigning tasks to different roles. For example, validation or fixing tasks that were assigned to a given role could be assigned to a different role.

Embodiments may be able to implement out of the box analytical monitoring for the process based on the templates. In particular, templates can be designed to provide reporting and analytic data to reporting systems within a business application fabric. For example, reporting and analytic data could be provided by various systems to the information management server 204. This server 204 could then provide such information to automated or human entities having need of the information.

There are various entities involved in business exception management. Such entities may include automated entities, such as machine implemented entities as described above, and human entities.

One group of entities involved in business exception management includes business analysts and information workers. Embodiments may be implemented to allow these human entities, such as entity 208, to own and manage certain business decisions, human workflows, and other resources. In particular, some embodiments include an interface, such as interface 206, accessible by these entities. Such an interface may be provided, in some embodiments, using a SharePointe site. Generally these entities are interested in business analytics. One example template definition may define user interface elements including a definition of a user interface site, may define group memberships defining entities in a group responsible for certain business analytics, and may define policies of the group. For example, such policies may include policies with respect to validation and/or assignment of tasks. For example, a validation policy may check to see if an exception occurred because an order value is too large and needs special validation. As another example, validation policy may require a check from a credit card company to determine whether a transaction is fraudulent or not. An example of assignment policy may be a policy where when a purchase order exceeds a threshold, assignment of approval issuance is delegated to the board of directors. At the other extreme, assignment policy may cause any message corruption issue to be automatically approved.

As noted, embodiments may include end to end analytics modelling. In particular various metrics regarding errors, error handling and other information may be collected. In particular, this can be facilitated by using templates allowing for more standardized ways of handling exceptions and more standardized ways of reporting information about exceptions. This information can be provided to business analysts and information workers, such as through an information management server 204 and a user interface 206.

In some embodiments, the above functionality for business analysts and information workers represents out of the box functionality. However, being a template based system, embodiments may be extensible as well. For example, tasks assigned to these entities can be extended in a custom template. Workflows defined for these entities can be extended in a custom template. Content types available to these entities may be defined in a custom template. A user interface used by these entities may be extensible in that various web parts and custom user interface elements can be defined.

Another group of entities may include application developers. Application developers own and/or manage application fabric workflows. Application developers may be interest in automating processes and creating generalized solutions. In particular, application developers develop and may deploy the automated machines that handle business process handling. Application developers may also develop custom application solutions to handle various aspects of business processing.

Application development for handling exceptions may include a number of different aspects. For example, the developer may need to create modules for implementing a business exception handler component. The business exception handler component includes one or more modules in the application fabric that handle business exception. The business exception handler component may make an exception contract available for export. The exception contract allows other portions of an application fabric to communicate exceptions to the business exception handler component. The business exception handler component may define workflow templates. In particular, the workflow templates may define various tasks for finding, fixing, and taking action on exceptions.

In addition to exception processing, developers may generally define how business processes flow and are accomplished. General business flows may include the ability to import exception contracts so that exceptions can be raised using appropriate data communication techniques. Additionally the general business flows can include functionality for raising exceptions using the imported business exception contract.

Embodiments herein may include various out of the box solution elements for developers. For example, embodiments may include templates with exception contracts defining how business exceptions can be handled. Embodiments may include user interface contracts defining how developers should implement user interfaces for human users. Embodiments may include configurable workflow templates for exceptions. Embodiments may include various policies for developers. For example one such policy may be a rule based find policies which can find the possible issues in the exception message. In particular, rules can be provided to help find problems. Embodiments may include provisions for data transformation. For example, embodiments may provide out of the box transformations of how data should be transformed or projected to different entities based on their role(s). Embodiments may include a number of patterns included in templates defining business exceptions in a business process. Developers can use these patterns to control business exception handling.

Embodiments may include functionality for extending basic functionality for developers by allowing developers to extend the templates. For example, embodiments may include the ability to extend workflow templates. Application developers can implement extended embodiments by writing custom validation code. Application developers can implement extended embodiments by modifying approval code. In particular, developers can redefine out of the box approvals defined in a template to allow different entities to perform approval tasks.

Another group of entities includes IT professions. The IT professionals own and/or manage deployed infrastructure. For example, IT professionals may manage user interface systems that allow users to interact with the business applications. IT professionals may manage the application fabric, including the different automated machines performing various business functions. IT professionals are interested in deployment and maintenance of user interfaces and the application fabric, including associated hardware and software.

Embodiments may include various out of the box features for IT professionals. For example, embodiments may include functionality for deploying and configuring applications in the application framework to implement business process. This may include functionality for configuring and deploying business exception composition. IT professionals can configure the way business process components communicate with business exception components. Embodiments may include functionality for configuring various user interfaces elements. For example, embodiments may include functionality for configuring how the information management server handles data and how information is provided via various user interfaces. IT professionals can configure information management servers 204. This can be used to report business exception analytics. For example, in one embodiment, an IT professional may be able to configure SharePoint® for SharePoint® activities. An IT professional may be able to create SharePoint® artifacts for business exception stages to be handled in SharePoint®.

Some out of the box solutions may provide exception workflow tracking. Additionally, some out of the box solutions may provide standard profiles with configuration. Embodiments may be extensible as well. For example, some embodiments may allow configurability in end to end business activity monitoring. Some embodiments may be extended to provide information management server tracking, such as SharePoint Action Tracking.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of handling business process exceptions, the method comprising a computing system in an application fabric performing the following:
using a template, causing one or more operations to be performed to determine a problem that caused a business process exception;
using the template, causing one or more operations to be performed to perform one or more repair operations to address the business process exception; and
using the template, causing one or more operations to be performed to take action on the business process exception.

2. The method of claim 1, wherein using a template, causing one or more operations to be performed to determine a problem that caused a business process exception comprises communicating with an entity, the entity being a role defined in the template for performing one or more problem finding operations.

3. The method of claim 1, wherein using the template, causing one or more operations to be performed to take action on the business process exception comprises communicating with an entity, the entity being a role defined in the template for performing action operations.

4. The method of claim 1, wherein using a template, causing one or more operation to be performed to perform one or more repair operations to address the business process exception comprises communicating with an entity, the entity being a role defined in the template for performing one or more repair operations.

5. The method of claim 4, wherein communicating with an entity comprises requesting and receiving approvals from an entity.

6. The method of claim 4, wherein communicating with an entity comprises placing a call to a service.

7. The method of claim 1, wherein the template comprises policies for developers.

8. The method of claim 1, wherein the template defines contracts for user interface elements.

9. The method of claim 1, further comprising capturing exceptions using a business exception activity in a workflow.

10. The method of claim 1, further comprising capturing exceptions using a subscription to a messaging server

11. The method of claim 1, wherein the template is configured to cause operations to be performed to provide reporting and analytic data to reporting systems within a business application fabric.

12. The method of claim 1, wherein the template implements policies for at least one of business analysis or information workers.

13. In a computing environment, a computer readable medium comprising computer executable instructions that when executed by one or more processors is configured to cause one or more processors to perform the following acts:
using a template, causing one or more operations to be performed to determine a problem that caused a business process exception;
using the template, causing one or more operations to be performed to perform one or more repair operations to address the business process exception; and
using the template, causing one or more operations to be performed to take action on the business process exception.

14. The computer readable medium of claim 13, wherein using a template, causing one or more operations to be performed to determine a problem that caused a business process exception comprises communicating with an entity, the entity being a role defined in the template for performing one or more problem finding operations.

15. The computer readable medium of claim 13, wherein using the template, causing one or more operations to be performed to take action on the business process exception comprises communicating with an entity, the entity being a role defined in the template for performing action operations.

16. The computer readable medium of claim 13, wherein using a template, causing one or more operation to be performed to perform one or more repair operations to address the business process exception comprises communicating with an entity, the entity being a role defined in the template for performing one or more repair operations.

17. The computer readable medium of claim 16, wherein communicating with an entity comprises requesting and receiving approvals from an entity.

18. The computer readable medium of claim 16, wherein communicating with an entity comprises placing a call to a service.

19. In a computing environment, a computing system configured to handle business process exceptions, the computing system comprising:
one or more processors;
one or more computer readable media coupled to the processors, wherein the one or more computer readable media comprises computer executable instructions that when executed by one or more of the one or more processors is configured to cause one or more or the one or more processors to perform the following acts:
using a template, causing one or more operations to be performed to determine a problem that caused a business process exception including communicating with a first entity with a role defined in the template for determining problems that cause business processes exceptions;
using the template, causing one or more operations to be performed to perform one or more repair operations to address the business process exception including communicating with a second entity with a role defined in the template for repairing problems, including requesting approvals from the second entity; and
using the template, causing one or more operations to be performed to take action on the business process exception including causing a process flow to be restarted.

20. The computing system of claim 19, wherein the computing system is a distributed computing system including local and remote computer systems.
